(19) United States
(12) Patent Application Publication
(10) Pub. No.: US 2010/0207374 A1
(43) Pub. Date: Aug. 19, 2010

(54) Bicycle fender allowing different color selection

(76) Inventor: HSU KUO-CHUNG, Hsiushui Hsiang (TW)

Correspondence Address: Guice Patents PLLC, 12647 Galveston Court #302, Manassas, VA, 20112, US

(21) Appl. No.: 12/003,220

(22) Filed: Dec. 20, 2007

(51) Int. Cl. B62J 15/00

(52) U.S. Cl. 280/852

(57) ABSTRACT

A bicycle fender allowing different color selection includes a frame and a panel. The frame has a body at the periphery formed in a shape of the fender, and at least one carved out zone and at least one fastening element to be coupled with the panel to form changeable color and pattern combinations that can be selected and installed according to users' requirements and preferences.

### BACKGROUND OF THE INVENTION

1. Field of the Invention

The present invention relates to a bicycle fender allowing different color selection and particularly to a bicycle fender allowing users to select different color and pattern combinations on a panel surface according to their requirements and preferences.

2. Description of the Prior Art

A conventional bicycle fender 9 (referring to FIG. 1) mainly includes a panel 90 with a fastening seat 91 at a front end to be fastened to the frame of a bicycle. Bicycle fender 9 thus formed usually is plain and lacks colorful appeal. While some people try to bond stickers to the panel 90 to enhance the aesthetic appeal, the ornamental area is limited and cannot fully rouse total aesthetic appeal.

### SUMMARY OF THE INVENTION

In view of the aforesaid problem, the present invention aims to provide a bicycle fender that permits different color selection. It has a frame and a panel. The frame has a body at the periphery formed in the shape of the fender. It has at least one carved out zone and at least one fastening element to allow the frame and the panel to be coupled together. By means of such a structure different color and pattern combinations can be formed and changed on the panel surface as desired to suit users' different requirements and preferences.

In one aspect the fastening element is located at an inner side of the border of the frame and is formed in a trough (or a bulged rim). It is preferably formed by extending the inner side of the border corresponding to a positioning portion at one edge of the panel. Such a structure can increase the coupling strength and bonding effect of the panel and the frame.

In another aspect the carved out zone of the panel is formed in any shape desired, and also may be a combination of texts or patterns.

In yet another aspect the border and the carved out zone are joined by at least one reinforced portion to support the border after the carved out zone is formed.

In yet another aspect the panel is a flexible blade. The positioning portion is coupled with the fastening element of the frame. The carved output zone is covered by the panel surface to form a colored bicycle fender.

In yet another aspect the fastening element is located at one side of the reinforced portion, and includes at least one first bonding element. The panel has at least one second bonding element corresponding to the first bonding element. The first and second bonding elements can be coupled to bond the frame and the panel together.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional fender.

FIG. 2 is an exploded view of the invention.

FIG. 3 is a perspective view of the invention.

FIG. 4 is a fragmentary sectional view of the invention.

FIG. 5 is another fragmentary sectional view of the invention.

FIG. 6 is yet another fragmentary sectional view of the invention.

FIG. 7 is an exploded view of a second embodiment of the invention.

FIG. 8 is a perspective view of the second embodiment of the invention.

FIG. 9 is a sectional view of the second embodiment of the invention.

FIG. 10 is an exploded view of yet another embodiment of the invention.

FIG. 11 is a schematic view of yet another embodiment of the invention in a use condition.

FIG. 12 is a sectional view of yet another embodiment of the invention in a use condition.

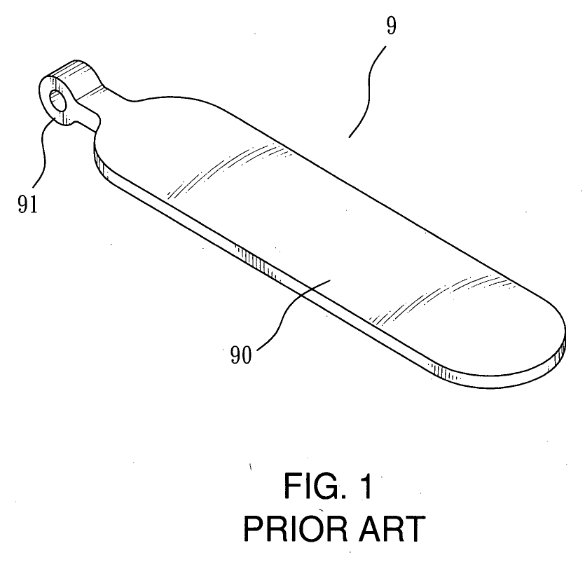

### DESCRIPTION OF THE PREFERRED EMBODIMENTS

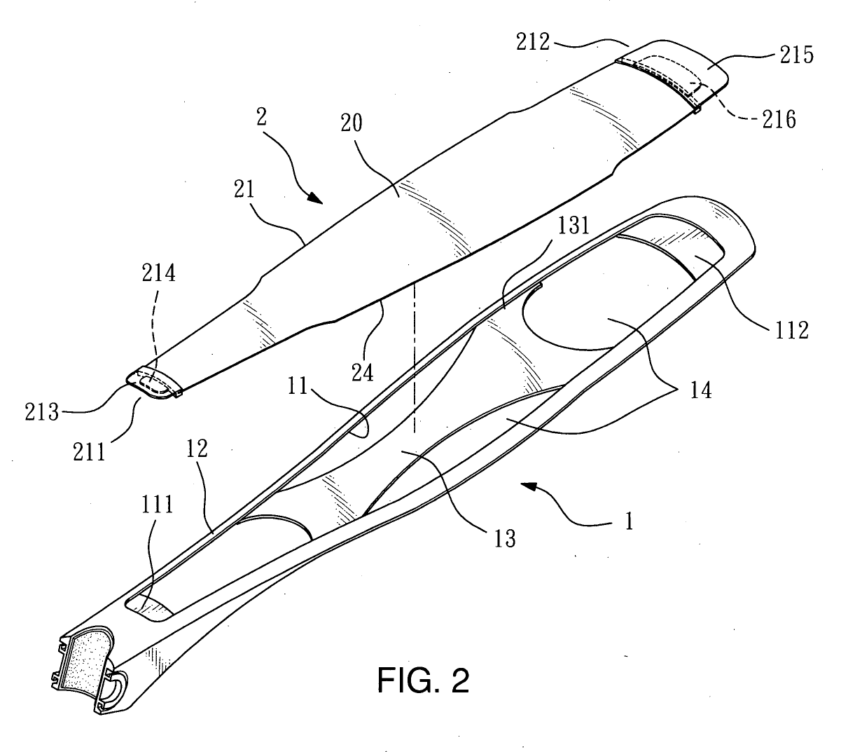

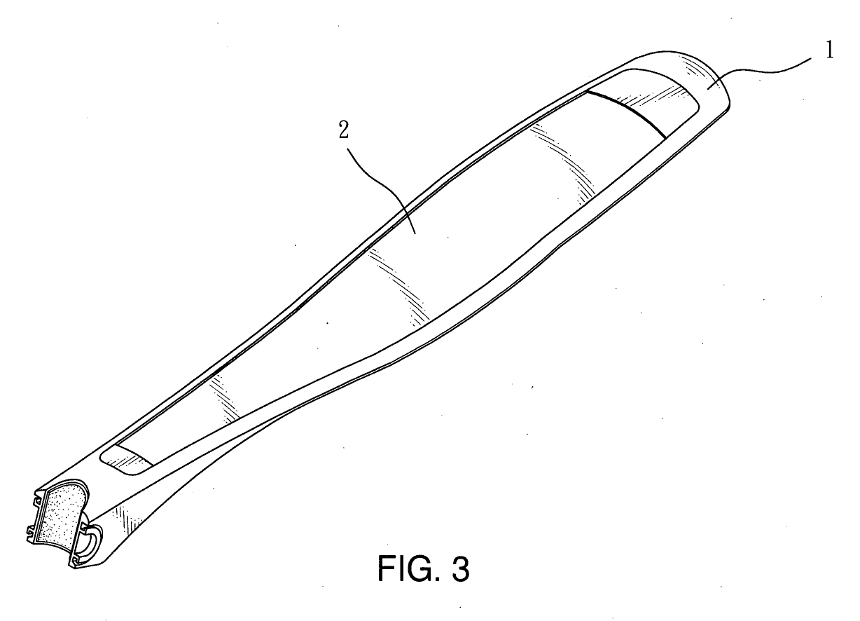

Please referring to FIGS. 2 through 6, the invention includes a frame 1 and a panel 2.

The frame 1 has a body at the periphery formed in a shape of the fender. It has at least one fastening element 11 and at least one carved out zone 14 formed thereon.

The panel 2 is a flexible blade and has at least one positioning portion 21 to be coupled with the fastening element 11 of the frame 1. The panel 2 has a panel surface 20 to cover an outer or inner side of the carved out zone 14 to form a changeable color selection combination.

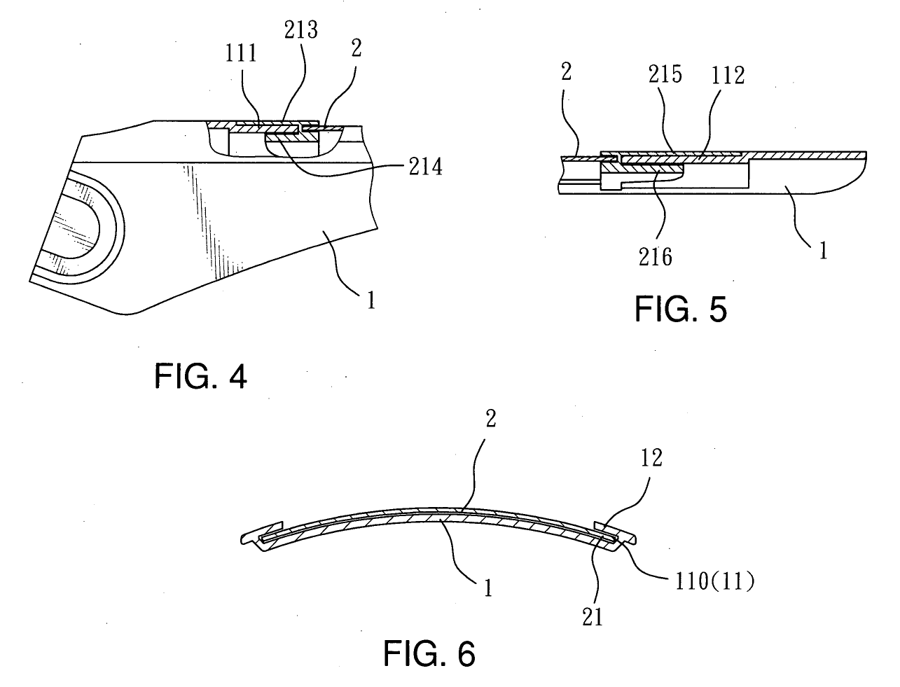

The fastening element 11 is located at an inner rim of a border 12 of the frame 1, and can be a trough (or a bulged rim with the positioning portion becoming a trough in such an occasion) 110. The trough 110 is preferably formed at the inner side of the border 12 corresponding to the positioning portion 21 so that the positioning portion 21 can be coupled evenly in the trough 110 to achieve a desired bonding effect and support strength (referring to FIG. 6). To further enhance the positioning effect of the fastening element 11, the border 12 may have a first bracing blade 111 and a second bracing blade 112 located at a front end and a rear end thereof. The panel 2 also has a front positioning end 211 (including a third bracing blade 213 and a first wedging blade 214) and a rear positioning end 212 (including a fourth bracing blade 215 and a second wedging blade 216) corresponding respectively to the first and second bracing blades 111 and 112. Therefore the first wedge blade 214 can be wedged between the first bracing blade 111 and third bracing blade 213 (referring to FIG. 4), and the second wedging blade 216 can be wedged between the second bracing blade 112 and the fourth bracing blade 215 (referring to FIG. 5) to increase the positioning effect.

The border 12 and carved out zone 14 have to be reinforced to increase the strength to support the frame 1. Hence at least one reinforced portion 13 is formed between the carved out zone 14 and the border 12. The reinforced portion 13 has one side 131 connecting to the border 12, and may be formed in any shape desired. It also may be printed with texts or patterns or a combination thereof to improve the aesthetic appeal.

By means of the structure set forth above, the panel 2 can be fastened to the frame 1, and is changeable to replace the panel surface 20 of different colors and patterns to suit individual user's requirements and preferences.

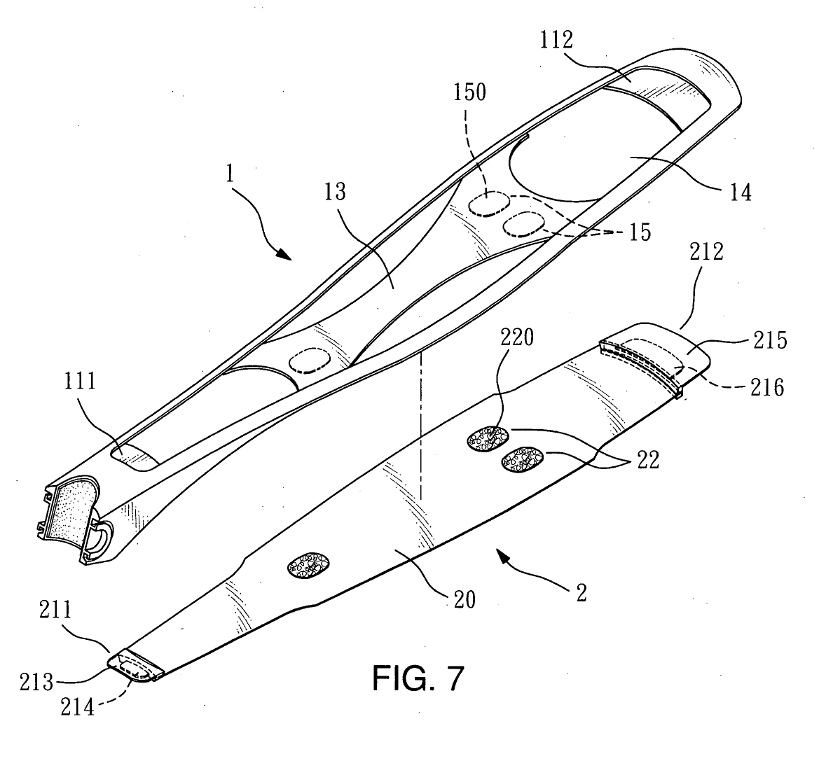

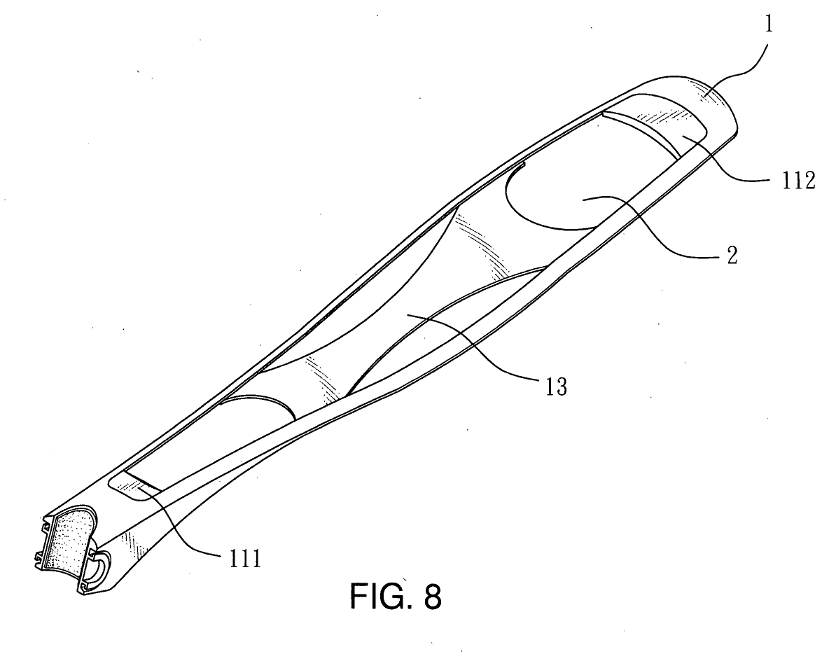

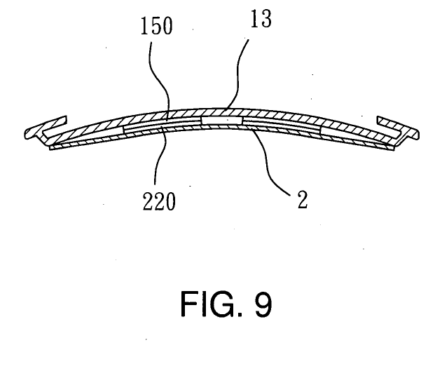

Referring to FIGS. 7, 8 and 9 for a second embodiment of the bicycle fender of the invention. The panel 2 may also be fastened to a lower side of the frame 1 to enrich the look of layer structure. The fastening element 15 may be located at one side of the reinforced portion 13 that includes at least one first bonding element 150. The panel 2 has a positioning portion 22 with the at least one second bonding element 220 corresponding to the first bonding element. While the third bracing blade 213 and the first wedging blade 214 at the front positioning end 211, and the fourth bracing blade 215 and the second wedging blade 216 are wedged respectively in the trough 110 of the frame 1 (referring to FIGS. 4 and 5), the first and second bonding elements 150 and 220 can be bonded together to bond the panel 2 to the frame 1 (referring to FIG. 9). By altering the color and pattern of the panel surface 20, a rich color and pattern combinations can be provided to meet user's requirements.

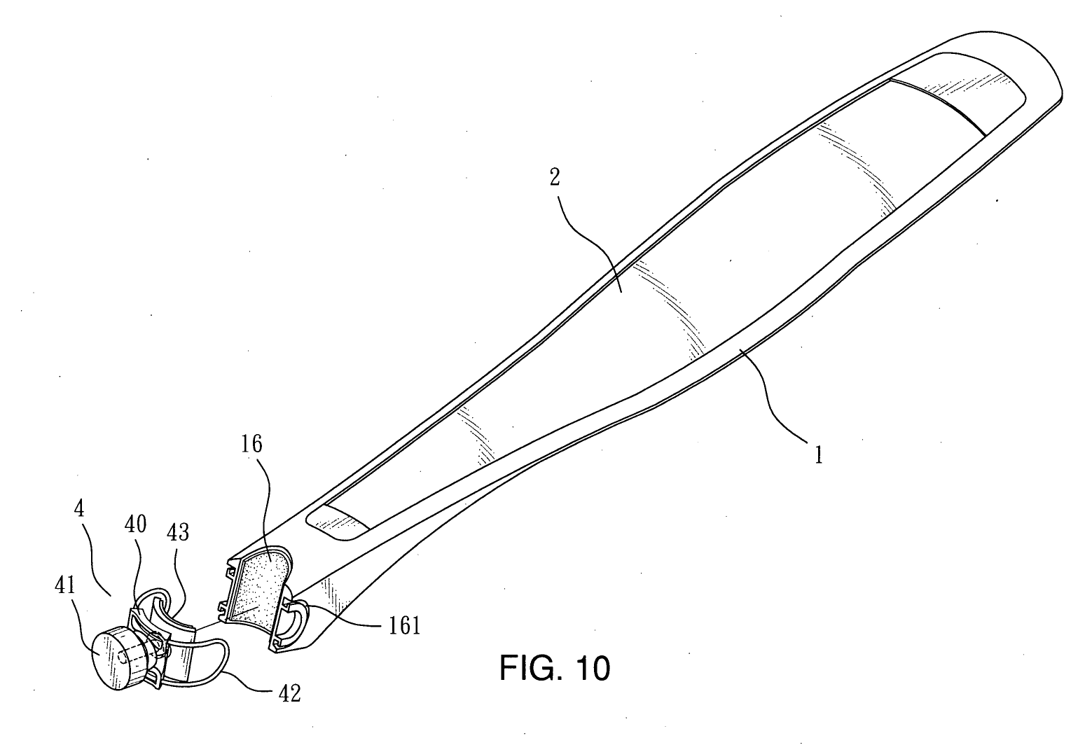

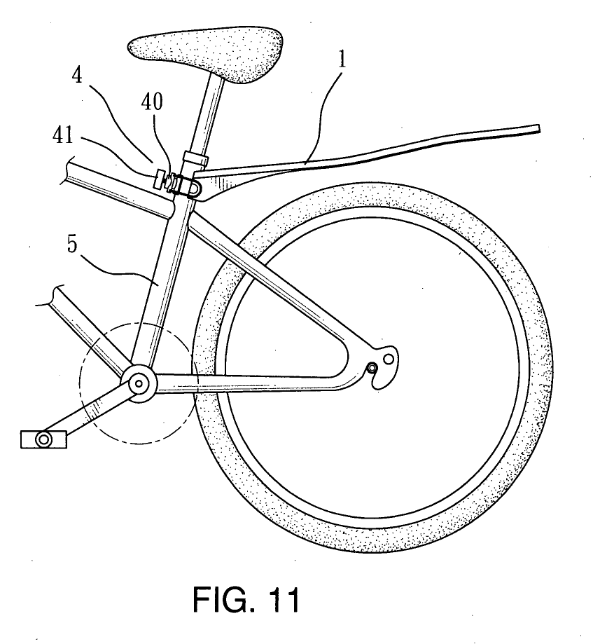

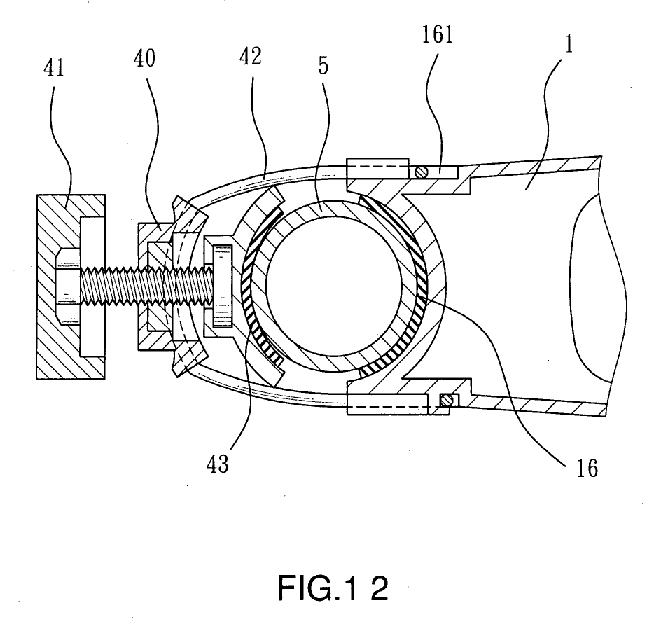

Refer to FIGS. 10, 11 and 12 for an embodiment for installing the invention on a bicycle frame. The frame 1 has a clipping portion 16 at one end to be coupled with a clipping means 4 so that it can be fastened to a bicycle frame 5.

The clipping portion 16 has a latch trough 161 at each of two sides.

The clipping means 4 includes a body 40 and an adjustment bolt 41. The body 40 has a latch band 42 at each of two sides to latch on the latch trough 161. The adjustment bolt 41 runs through the body 40 with a clipping element 43 at a distal end.

By means of such a structure, the clipping portion 16 and the clipping means 4 can be coupled on the bicycle frame 5. By adjusting the adjustment bolt 41 the tightness of the latch band 42 can be adjusted to securely fasten the fender to the bicycle frame 5.

As a conclusion, the invention allows users to select different color and pattern combinations according to their requirements and preferences. It provides a significant improvement over the conventional bicycle fenders.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A bicycle fender allowing different color selection comprising a frame and a panel; wherein:
the frame has a body formed in a shape of the fender at the periphery thereof, and at least one fastening element and at least one carved out zone; and
the panel is a flexible blade and has at least one positioning portion coupling with the fastening element and a surface covering the carved out zone to form a combination with changeable color.

2. The bicycle fender of claim 1, wherein the fastening element is a trough formed on an inner rim of a peripheral border of the frame.

3. The bicycle fender of claim 1, wherein the peripheral border of the frame has a front end which has a first bracing blade, the panel having a third bracing blade and a first wedging blade to be wedged with the first bracing blade.

4. The bicycle fender of claim 1, wherein the peripheral border of the frame has a rear end which has a second bracing blade, the panel having a fourth bracing blade and a second wedging blade to be wedged with the second bracing blade.

5. The bicycle fender of claim 1 further having at least one reinforced portion adjacent to the peripheral border and the carved out zone, the reinforced portion having one side connecting to the peripheral border.

6. The bicycle fender of claim 1, wherein the fastening element is located at one side of the reinforced portion and has at least one first bonding element located thereon corresponding to the positioning portion of the panel, the positioning portion having at least one second bonding element.
